(19) United States
(12) Patent Application Publication
(10) Pub. No.: US 2006/0050674 A1
(43) Pub. Date: Mar. 9, 2006

(54) Handoff system and method between mobile communication network and wireless LAN

(75) Inventors: Sang-Do Lee, Suwon-si (KR); Dong-Keon Kong, Suwon-si (KR); Hye-Won Baek, Seongnam-si (KR); Sang-Jun Moon, Yongin-si (KR); Ji-Cheol Lee, Yongin-si (KR); Eun-Young Chung, Suwon-si (KR); Heung-Chul Jung, Suwon-si (KR); Jong-Bum Pyo, Yongin-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/220,390

(22) Filed: Sep. 7, 2005

(30) Foreign Application Priority Data
Sep. 7, 2004 (KR) 2004-71257

(51) Int. Cl. H04Q 7/24

(52) U.S. Cl. 370/338

(57) ABSTRACT

A handoff method is provided between a mobile communication network including a packet data service node (PDSN), connected to a base station system (BSS), for supporting an Internet protocol (IP) routing function, and a wireless local area network (LAN) including an access router (AR) supporting the IP routing function. Upon detecting handoff to the wireless LAN, an access terminal (AT) with a contact set up to the PDSN exchanges a data packet with a correspondent node (CN) via a tunnel between the AR and the PDSN. The AT determines a user traffic state according to a transmission/reception state of the data packet, and changes the contact connected to the AT according to the user traffic state.

### PRIORITY

This application claims the benefit under 35 U.S.C. § 119(a) of a Korean Patent Application entitled “System and Method of Managing Internet Protocol Packet Between Mobile Communication Network and Wireless LAN” filed in the Korean Intellectual Property Office on Sep. 7, 2004 and assigned Serial No. 2004-71257, the entire contents of which are hereby incorporated by reference.

### BACKGROUND OF THE INVENTION

1. Field of the Invention

The present invention relates generally to a handoff system and method in a wireless communication system. In particular, the present invention relates to a handoff system and method between a cellular mobile communication network and a wireless Local Area Network (LAN).

2. Description of the Related Art

An early mobile communication network has been developed for voice communication. However, with the rapid progresses in communication technologies, the mobile communication network is now evolving into a system capable of supporting high-speed data transmission, in which a user can receive not only the common voice service but also a multimedia service such as E-mail, still image, and moving image services.

The mobile communication network will now be described with reference to FIG. 1. Referring to FIG. 1, an access terminal (AT) 100 is connected to a base station system (BSS) 101 through a radio channel. The AT 100 comprises a dual-mode terminal capable of accessing both a mobile communication network and a wireless LAN, and the dual-mode terminal is called a “hybrid access terminal.” It will be assumed herein that the AT 100 comprises a hybrid access terminal. The BSS 101 is connected to an undepicted packet control function (PCF) that controls an exchange of packet data between the AT 100 and the BSS 101 to perform packet data communication. The PCF is connected to a packet data service node (PDSN) 102 that transmits and receives packet data. The PDSN 102 provides an Internet protocol (IP) routing function and a vertical handoff function to the AT 100 that accesses an IP network 108 via the mobile communication network. Further, the PDSN 102 performs point-to-point protocol (PPP) connection on the AT 100 that accesses the IP network 108 via the mobile communication network. In Mobile IP, the PDSN 102 can serve as a foreign agent (FA). The PDSN 102 allocates an IP address used by the AT 100 by performing link control protocol (LCP) negotiation (or LCP association) with the AT 100, performing challenge handshake authentication protocol (CHAP) authentication, and thereafter, performing IP control protocol (IPCP) negotiation (or IPCP association) with the AT 100.

In a wireless LAN of FIG. 1, the AT 100 can perform wireless communication within the coverage area of an access point (AP) 103 by using a radio frequency. The AT 100 which performs the wireless communication selects one of a plurality of APs by measuring the strength of signals therefrom, and then accesses the selected AP 103. The AP 103 processes a wireless LAN access protocol, and serves as a bridge between a wireless LAN and a wired LAN. The AP 103 is connected to an access router (AR) 104 through a wire. The AR 104 provides an IP routing function, a vertical handoff function and an accounting/authentication function to the AT 100 that accesses the IP network 108 via the wireless LAN. Although shown as two separate components, the AP 103 and AR 104 can alternately be embodied in a single device.

The purpose of the mobile communication network and the wireless LAN is to provide full mobility to a user of the AT 100. That is, even though the AT 100 moves from the mobile communication network 110 to the wireless LAN 120, the communication should continue seamlessly. In order to provide mobility to the user, the AT 100 in communication should perform handoff while moving from the mobile communication network to the wireless LAN and vice versa.

Generally, the term “handoff” refers to a process of maintaining a channel so that a call continues seamlessly even when an AT in communication moves between base stations (BSSs or APs). The handoff can be divided into hard handoff and soft handoff. Because these processes are well known in the art, a description thereof will be omitted herein for clarity and conciseness.

Unlike the general handoff, the vertical handoff refers to handoff between networks employing different technologies. That is, the vertical handoff occurs when the AT 100 that was allocated an IP address from the PDSN 102 via the BSS 101 and has created sessions of upper network layers, for example, an application layer and a TCP/UDP layer, moves to the wireless LAN.

During the vertical handoff, the AT 100 cannot receive packets transmitted from the mobile communication network and must be allocated a new IP address in order to access the wireless LAN, so that it cannot maintain the sessions of the upper layers.

Every time the type of the network that the AT 100 accesses changes, a new protocol for updating an IP address of the AT 100 is required. In this case, the AT 100 is dynamically allocated an IP address by using a dynamic host configuration protocol (DHCP). Because a format of the DHCP message is well known, a description thereof will be omitted herein for clarity and conciseness.

When the AT 100 moves from the mobile communication network 110 to the wireless LAN 120 as stated above, an IP address of the AT 100 is updated and IP packets are delivered from a correspondent node (CN) 105, which comprises an external server or a host, to the AT 100 via the IP network 108, the AR 104 and the AP 103. In the network configuration of FIG. 1, it is also possible to use Mobile IP in order to maintain the upper layer sessions and provide a seamless handoff during the vertical handoff process for the AT 100.

FIG. 2 is an exemplary diagram illustrating a conventional IP packet delivery process for the case where an AT moves from a mobile communication network to a wireless LAN using Mobile IP.

When Mobile IP is used, an AT 100 can maintain the same IP address, even after the vertical handoff, using a home address managed through a home agent (HA) 106. The HA 106 intercepts a packet being delivered to the AT 100 via an existing IP packet delivery route 130, and delivers (forwards) the intercepted packet to the AT 100 through a new IP tunneling route 140, providing a seamless handoff service to a certain extent. However, in Mobile IP, a time delay may occur due to mobility determination and signaling transmission, and traffic is concentrated on the HA 106 because the HA 106 must intercept the packets delivered from the CN 105 to the AT 100.

### SUMMARY OF THE INVENTION

It is, therefore, an object of the present invention to address a handoff system and method between a mobile communication network and a wireless local area network (LAN), for providing a seamless service when an access terminal (AT) moves from the mobile communication network to the wireless LAN.

It is another object of the present invention to address a handoff system and method between a mobile communication network and a wireless LAN, for transmitting/receiving Internet protocol (IP) packets by using the existing IP address when an AT moves from the mobile communication network to the wireless LAN.

It is further anther object of the present invention to address a handoff system and method between a mobile communication network and a wireless LAN, capable of determining whether to extend a route when an AT moves from the mobile communication network to the wireless LAN.

It is yet another object of the present invention to address a handoff system and method between a mobile communication network and a wireless LAN, capable of ending extension of a route when an AT moves from the mobile communication network to the wireless LAN.

It is still another object of the present invention to address a handoff system and method between a mobile communication system and a wireless-LAN, capable of preventing a loss of IP packets and reducing a call processing time by simplifying a handoff process when an AT moves from the mobile communication network to the wireless LAN.

It is still another object of the present invention to address a handoff system and method between a mobile communication network and a wireless LAN, capable of maintaining sessions of upper layers when an AT moves from the mobile communication network to the wireless LAN.

According to one exemplary aspect of the present invention, a handoff method is provided between a mobile communication network comprising a packet data service node (PDSN) connected to a base station system (BSS) for supporting an Internet protocol (IP) routing function and a wireless local area network (LAN) comprising an access router (AR) for supporting the IP routing function. The handoff method comprises the steps of exchanging a data packet with a correspondent node (CN) via a tunnel between the AR and the PDSN by an access terminal (AT) with a contact set up to the PDSN upon detecting handoff to the wireless LAN, determining a user traffic state according to a transmission/reception state of the data packet, and changing the contact connected to the AT according t the user traffic state.

According to another exemplary aspect of the present invention, a handoff method is provided between a mobile communication network comprising a packet data service node (PDSN), connected to a base station system (BSS), for supporting an Internet protocol (IP) routing function, and a wireless local area network (LAN) comprising an access router (AR) for supporting the IP routing function. The handoff Method comprises the steps of detecting movement of an access terminal (AT) to the wireless LAN with a contact set up to the PDSN, providing the AR with information for tunneling between the PDSN and the AR, setting up a tunnel for data packet delivery between the AR and the PDSN, exchanging a data packet with a correspondent node (CN) via the set tunnel, determining a user traffic state according to a transmission/reception state of the data packet, and changing the contact connected to the AT according to the user traffic state.

According to further another exemplary aspect of the present invention, a handoff apparatus is provided for an access terminal (AT) that moves from a mobile communication network comprising a packet data service node (PDSN), connected to a base station system (BSS), for supporting an Internet protocol (IP) routing function, to a wireless local area network (LAN) comprising an access router (AR) supporting the IP routing function. The handoff apparatus comprises a flow monitor for providing information indicating a transmission/reception state of a data packet of the AT, and a flow state manager for determining a user traffic state according to the transmission/reception state of the data packet, and changing a contact of the AT according to the user traffic state.

According to yet another exemplary aspect of the present invention, a wireless communication system is provided for performing handoff of an access terminal (AT) that moves from a mobile communication network comprising a packet data service node (PDSN), connected to a base station system (BSS), for supporting an Internet protocol (IP) routing function, to a wireless local area network (LAN) comprising an access router (AR) supporting the IP routing function. The wireless communication system comprises an AT comprising a dual-mode function for accessing both the mobile communication network and the wireless LAN, for determining a user traffic state according to a transmission/reception state of a data packet and changing a contact according to the user traffic state, and the AR for allocating a new IP address to the AT if the contact of the AT is changed.

### BRIEF DESCRIPTION OF THE DRAWINGS

The above and other objects, features and advantages of embodiments of the present invention will become more apparent from the following detailed description when taken in conjunction with the accompanying drawings in which:

FIG. 1 is an exemplary block diagram illustrating a conventional Internet protocol (IP) packet delivery route between a mobile communication network and a wireless local area network (LAN);

FIG. 2 is an exemplary block diagram illustrating a conventional Mobile IP-based IP packet delivery route between a mobile communication network and a wireless LAN;

FIG. 3 is an exemplary block diagram illustrating a configuration of a handoff system provided to solve the problems of FIGS. 1 and 2 during handoff between a mobile communication network and a wireless LAN according to an embodiment of the present invention;

FIG. 4 is an exemplary block diagram of an access terminal (AT) supporting handoff between a mobile communication network and a wireless network according to an embodiment of the present invention;

FIG. 5 is an exemplary state transition diagram illustrating a user traffic state of an AT according to an embodiment of the present invention;

FIG. 6 is an exemplary flowchart illustrating an operation of a flow state manager in an AT according to an embodiment of the present invention; and

FIG. 7 is an exemplary signaling diagram illustrating a handoff method between a mobile communication network and a wireless LAN according to an embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the accompanying drawings. In the following description, a detailed description of known functions and configurations has been omitted for clarity and conciseness.

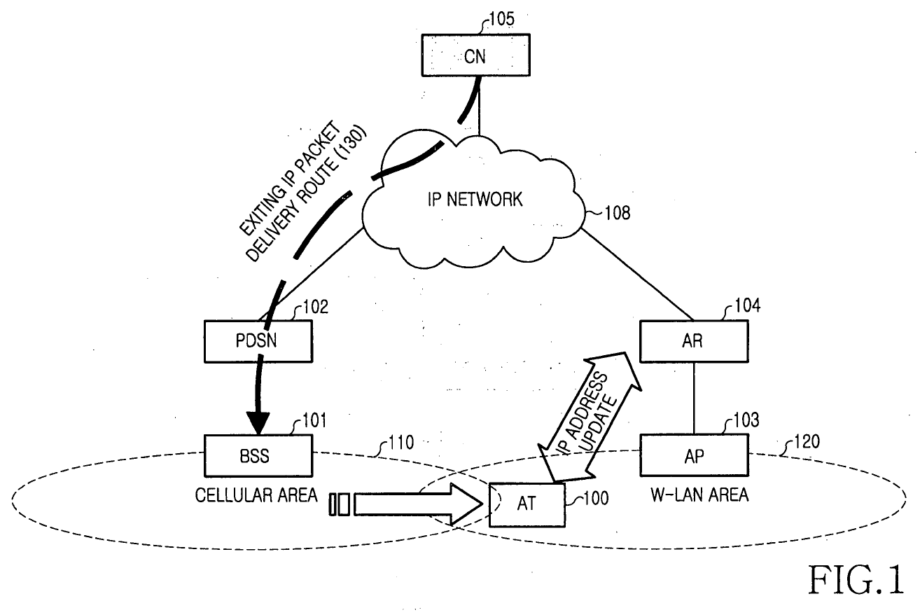

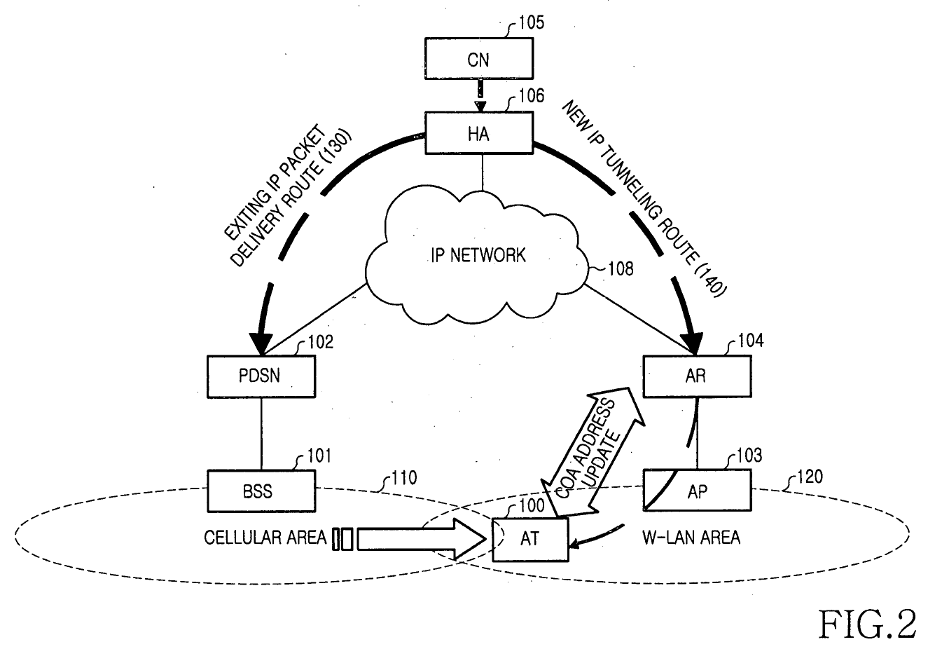

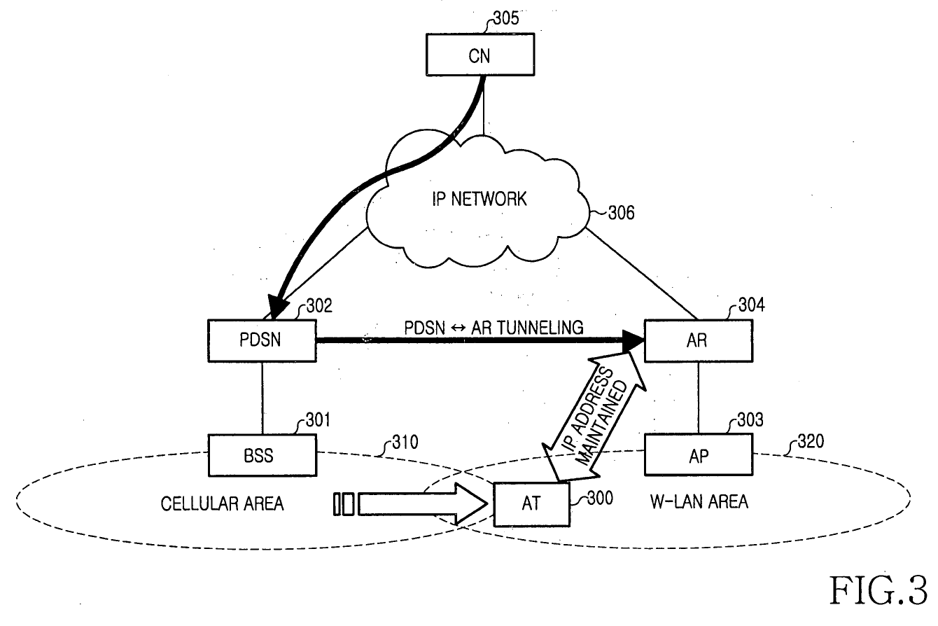

FIG. 3 is an exemplary diagram illustrating a configuration of a handoff system provided to solve the problems of FIGS. 1 and 2 during handoff from a mobile communication network to a wireless local area network (LAN).

It will be assumed that an access terminal (AT) 300, exchanging Internet protocol (IP) packets with a correspondent node (CN) 305, moves from a mobile communication network 310 to a wireless LAN 320. While the AT 300 exchanges packet data with a BSS 301 located in the mobile communication network 310, if strength of signals from the BSS 301 becomes less than a predetermined threshold and strength of signals from an AP 303 located in the wireless LAN 320 becomes greater than a predetermined threshold, the AT 300 detects handoff from the mobile communication network to the wireless LAN. Upon detecting the handoff from the mobile communication network to the wireless LAN, the AT 300 searches for (or selects) an access router (AR) 304 supporting handoff between the mobile communication network and the wireless LAN, and provides an AT IP address and a packet data service node (PDSN) IP address, both of which were used by the AT 300 in the mobile communication network, to the selected AR 304.

In order for the AT 300 to maintain the existing IP address used in the mobile communication network before the handoff to the wireless LAN, the handoff system sets up a tunnel between the AR 304 in the wireless LAN and a (PDSN) 302 in the mobile communication network. When the AT 300, after moving to the wireless LAN, delivers IP packets up to the CN 305 through the tunnel, the IP packets are not delivered to the CN 305 by a routing function of the AR 304, but rather are delivered to the PDSN 302 through the tunnel between the AR 304 and the PDSN 302 and then delivered up to the CN 305 by a routing function of the PDSN 302.

If the AT 300 continues to receive IP packets delivered from the CN 305 through the tunnel between the PDSN 302 and the AR 304 as described above, a route from the mobile communication network to the wireless LAN is extended. The extension of the route increases a traffic load of a core network (CN). This is because the extension of the route increases the number of nodes (for example, PDSN, AR, and so on.) through which the traffic is delivered to the same AT, and the increase in the number of the nodes increases the amount of the traffic that must be processed by the nodes, as a whole of the core network. In addition, the extension of the route causes a delay in end-to-end signal delivery, and increases the number of the intermediate nodes, causing resource waste. Further, the extension of the route generates a loop of a traffic delivery route between the mobile communication network and the wireless LAN. The loop of the delivery route refers to a delivery route that returns back to its start point according to a moving route of an AT. The loop of the delivery route unnecessarily increases the traffic delivery route. For example, when an AT starts a node A and returns back to the node A after passing through nodes B, C and D, the traffic delivery route generates a loop of A→B→C→D→A. In addition, in order to continuously maintain an IP address of the AT 300, the PDSN 302 needs to efficiently manage the IP address.

Therefore, an exemplary embodiment of the present invention proposes a method capable of determining whether to extend a route when an AT moves from the mobile communication network to the wireless LAN.

In addition, an exemplary embodiment of the present invention provides a method for changing a Layer 3 contact from a PDSN to an AR when an AT has no more data to transmit/receive through an extended route after moving to the wireless LAN.

Moreover, an exemplary embodiment of the present invention proposes a method for ending the route extension by updating an IP address of an AT.

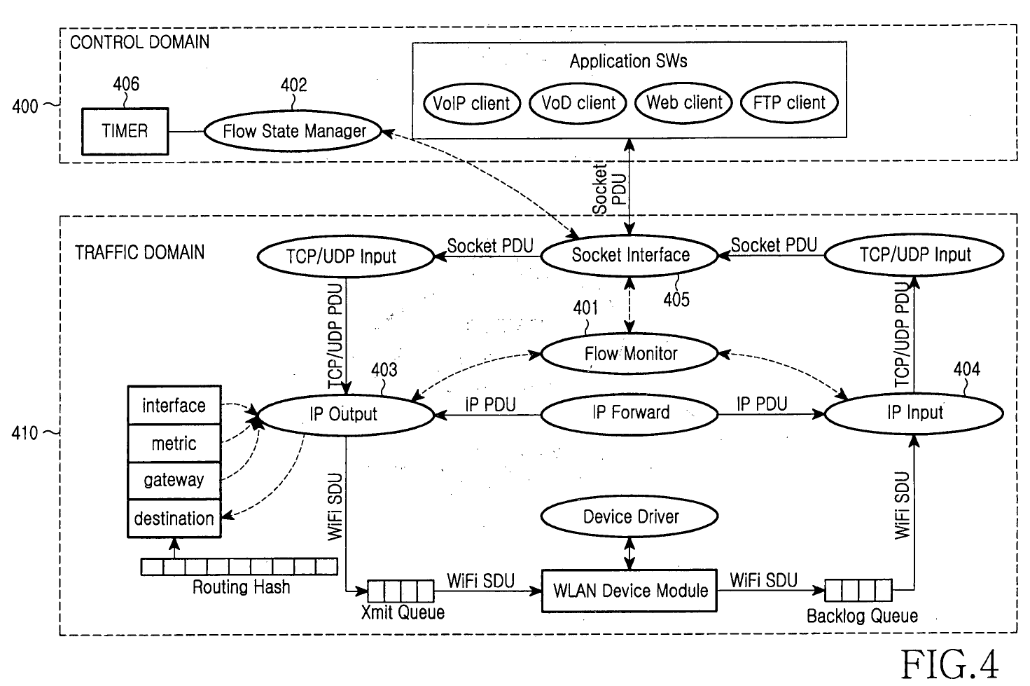

FIG. 4 is an exemplary block diagram of an AT for supporting handoff between a mobile communication network and a wireless network according to an exemplary embodiment of the present invention. Referring to FIG. 4, a description will now be made of an AT for efficiently managing IP packets during handoff between a mobile communication network and a wireless LAN according to an exemplary embodiment of the present invention. FIG. 4 is a diagram for a description of a process of internally processing IP packets exchanged with a CN 305 by an AT 300 after handoff from the mobile communication network to the wireless LAN.

The AT 300 is divided into a control domain 400 and a traffic domain 410.

The control domain 400 comprises a flow state manager 402 and a timer 406, and provides a service by controlling the traffic domain 410. The service comprises Video on Demand (VoD), Web, File Transfer Protocol (FTP), and so on.

While performing communication with the CN 305, the AT 300 receives IP packets delivered by the CN 305 from an IP input module 404, and transmits user data to an upper layer. In addition, when the upper layer delivers user data to the CN 305, an IP output module 403 transmits IP packets to the CN 305. In this case, the IP output module 403 determines an interface, a metric, a gateway and a destination for the IP packets by using a routing table.

The traffic domain 410 comprises a flow monitor 401, and monitors user traffic information through IP packets exchanged with the AT 300. The traffic domain 410 provides the monitored user traffic information to the flow state manager 402 in the control domain 400.

That is, the flow monitor 401 and the flow state manager 402 are function elements newly defined in the AT 300 according to an exemplary embodiment of the present invention to monitor user traffic of the AT 300.

In particular, while monitoring the IP output module 403 and the IP input module 404 realized in an IP stack, the flow monitor 401 detects a transmission/reception state of IP packets and provides the detected information to the flow state manager 402 via a socket interface 405. The flow state manager 402 inquires the transmission/reception state of the IP packets from the flow monitor 401 and at the same time, the timer 406 starts. In addition, the flow state manager 402 manages the user traffic in an ‘active’ state and an ‘idle’ state by controlling the flow monitor 401.

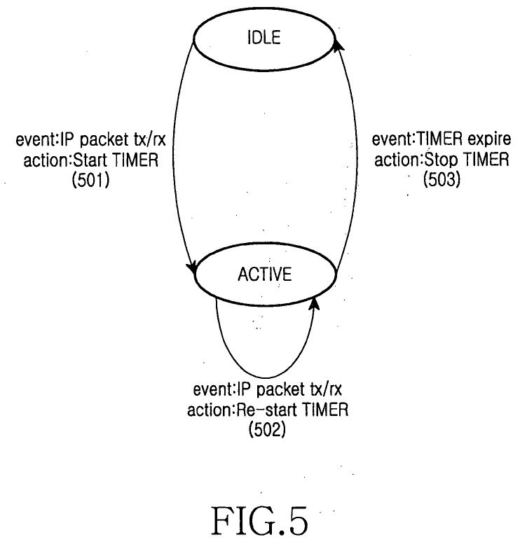

FIG. 5 is an exemplary state transition diagram illustrating a user traffic state of an AT according to an exemplary embodiment of the present invention. FIG. 5 illustrates a state transition diagram of user traffic managed by the flow state manager 402. A description of the state transition of the user traffic will be separately made for the following three cases.

First, the flow state manager 402 of the AT 300 periodically inquires of the flow monitor 401 via the socket interface 405 when the user traffic state is the ‘idle’ state because no transmission/reception of IP packets exists. Thereafter, upon receiving a notification for indicating transmission/reception of IP packets from the flow monitor 401, the flow state manager 402 sets the user traffic state to the ‘active’ state as shown by reference numeral 501. Thereafter, the flow state manager 402 periodically acquires of the flow monitor 401, and at the same time, the timer 406 starts.

Second, the flow state manager 402 periodically inquires of the flow monitor 401 via the socket interface 405 in the ‘active’ state of the user traffic state. Thereafter, upon receiving a notification for indicating transmission/reception of IP packets from the flow monitor 401, the flow state manager 402 sets the user traffic state to the ‘active’ state as shown by reference numeral 502. Thereafter, the flow state manager 402 periodically acquires of the flow monitor 401, and at the same time, the timer 406 re-starts.

Third, the flow state manager 402 acquires of the flow monitor 401 via the socket interface 405 in the ‘active’ state. Thereafter, if the timer 406 expires before a notification for indicating transmission/reception of IP packets is received from the flow monitor 401, the flow state manager 402 sets the user traffic state to the ‘idle’ state as shown by reference numeral 503. Thereafter, the flow state manager 402 acquires of the flow monitor 401, and at the same time, the timer 406 stops.

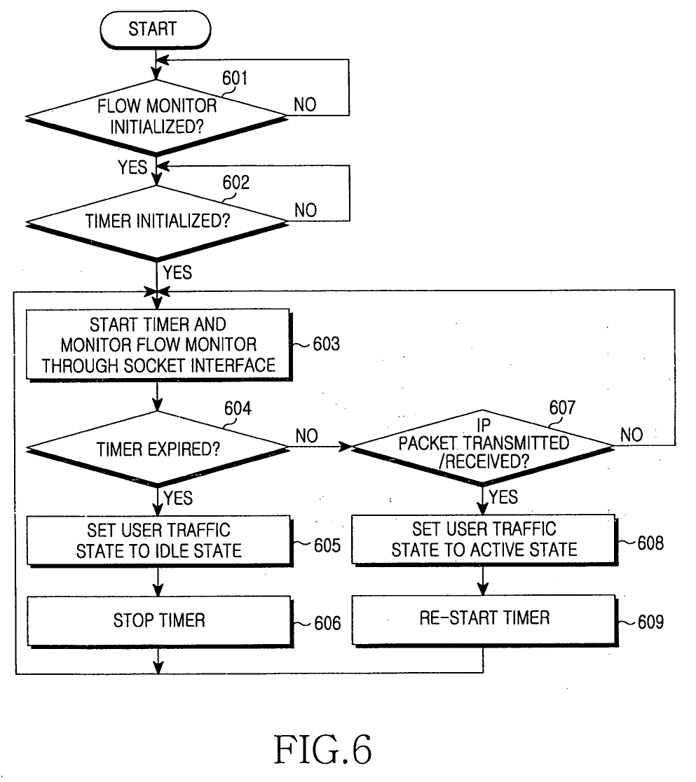

FIG. 6 is an exemplary flowchart illustrating an operation of a flow state manager in an AT according to an exemplary embodiment of the present invention. Referring to FIG. 6, a description will now be made of a method for managing the user traffic state by the flow state manager according to an exemplary embodiment of the present invention.

A flow state manager 402 of an AT 300 determines in step 601 whether a flow monitor 401 is initialized. If the flow monitor 401 is not initialized, the flow state manager 402 stays in a stand-by state until the flow monitor 401 is initialized. However, if the flow monitor 401 is initialized, the flow state manager 402 determines in step 602 whether a timer 406 is initialized. If the timer 406 is not initialized, the flow state manager 402 stays in the stand-by state. However, if the timer 406 is initialized, the flow state manager 402 proceeds to step 603 where it starts the timer 406 and at the same time, inquires a transmission/reception state of IP packets from the flow monitor 401 via a socket interface 405.

Thereafter, the flow state manager 402 determines in step 604 whether the timer 406 has expired. If the timer 406 has expired, the flow state manager 402 sets the user traffic state to the ‘idle’ state in step 605, determining that no transmission/reception of IP packets in the AT 300 exists, and then the timer 406 stops in step 606.

However, if it is determined in step 604 that the timer 406 has not expired, the flow state manager 402 determines in step 607 whether transmission/reception of IP packets exists according to the monitoring result of the flow monitor 401. If it is determined from the monitoring result of the flow monitor 401 of the AT 300 that no transmission/reception of IP packets exists, the flow state manager 402 returns to step 603 where the timer 406 and monitors the flow monitor 401 via the socket interface 405. However, if it is determined from the monitoring result of the flow monitor 401 of the AT 300 that transmission/reception of IP packets exists, the flow state manager 402 sets the user traffic state to the ‘active’ state in step 608, re-starts the timer 406 in step 609, and returns to step 603 to continue monitoring the flow monitor 401.

Therefore, when the AT 300 is handed off from a mobile communication network to a wireless LAN, the flow state manager 402 of the AT 300 changes the Layer 3 contact from a PDSN 302 to an AR 304 and the AR 304 allocates a new IP address of the AT 300, in the ‘idle’ state of the user traffic state. Therefore, the AT 300 can deliver the IP packets up to a CN 305 by a routing function of the AR 304. Herein, “Layer 3” refers to a network layer in an Open System Interconnection (OSI) seven layer system.

During the handoff from the mobile communication network and the wireless LAN, the flow state manager 402 of the AT 300 extends the route and allows an exchange of IP packet data between the AT 300 and the CN 305 through a tunnel between the AR 304 and the PDSN 302, in the ‘active’ state of the user traffic state.

Therefore, when a handoff from the mobile communication network to the wireless LAN exists, the AT 300 can determine whether it will extend the route as described with reference to FIG. 3, or it will change the Layer 3 contact from the PDSN 302 to the AR 304 according to an exemplary embodiment of the present invention, using the foregoing user traffic state management method. In addition, the AR 304 can determine whether to update an IP address of the AT 300.

If the user traffic state is changed to the ‘idle’ state because of no IP packet delivery for a predetermined time after completion of the vertical handoff from the mobile communication network to the wireless LAN, the AT 300 determines to change the Layer 3 contact from the PDSN 302 to the AR 304. In addition, the AT 300 requests the AR 304 to release the tunnel to the PDSN 302 and allocate a new IP address. Table 1 below shows an exemplary ‘A-P tunnel request’ option used when the AT 300 requests the release of the tunnel between the AR 304 and the PDSN 302.

TABLE 1

| | Length | | | | | | | | | |
|---|---|---|---|---|---|---|---|---|---|---|
| Field Name | (bytes) | Description | | | | | | | | |
| code | 1 | 84 | | | | | | | | |
| len | 1 | 5 | | | | | | | | |
| request flag | | 1 | 2 | 3 | 4 | 5 | 6 | 7 | 8 | REL: A-P tunnel |

| | | | |
|---|---|---|---|
| 1 | REL | reserved | release request |

| | | |
|---|---|---|
| anchor IP | 4 | IP address of PDSN that is used for PDSN⇄AR tunneling |

Referring Table 1, the ‘A-P tunnel request’ option comprises 1-byte ‘code’ information, 1-byte ‘len’ (length) information, 1-byte ‘request flag’ information, and 4-byte ‘anchor IP’ address.

Among them, the request flag information is comprised of a 1-bit A-P tunnel release request field and a 7-bit reserved field.

The A-P tunnel release request field is used by the AT 300 for requesting release of the tunnel between the AR 304 and the PDSN 302.

The anchor IP field is used by the AT 300 for informing the AR 304 of an IP address of the PDSN 302 that the AT 300 is accessing in the mobile communication network.

If the AT 300 no longer transmits/receives IP packets or is powered-off, the AT 300 can release the tunnel between the AR 304 and the PDSN 302 according to the following process.

In order to release the tunnel between the AR 304 and the PDSN 302, the AT 300 generates a DHCPINFORM message comprising the ‘A-P tunnel request’ option shown in Table 1, and delivers the DHCPINFORM message to the AR 304 on a unicast basis. An ‘anchor IP’ value of the ‘A-P tunnel request’ option is set to an IP address of the PDSN 302 to which the AT 300 allocated an IP address when it is located in the mobile communication network 310, and an REL flag of the ‘request flag’ is set to ‘1’.

Upon receiving the DHCPINFORM message comprising the ‘A-P tunnel request’ option, the AR 304 releases the tunnel to the PDSN 302.

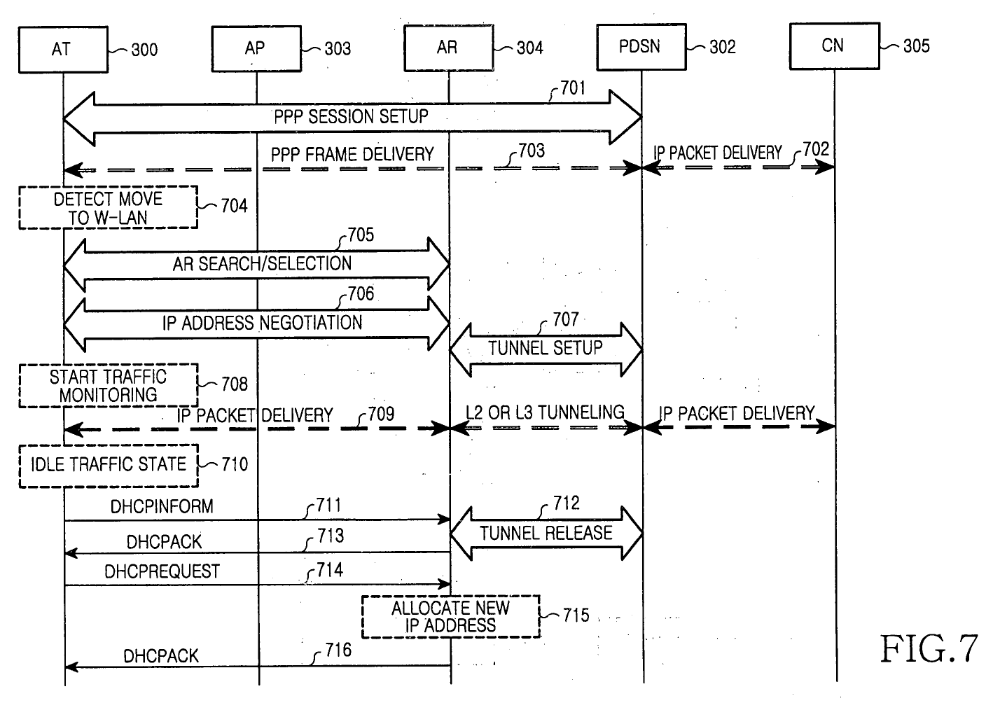

FIG. 7 is an exemplary signaling diagram illustrating a handoff method between a mobile communication network and a wireless LAN according to an exemplary embodiment of the present invention. Referring to FIG. 7, a description will now be made of a handoff method between a mobile communication network and a wireless LAN according to an exemplary embodiment of the present invention.

In step 701, an AT 300 accesses a mobile communication network via a BSS 301 and sets up a PPP session to a PDSN 302, forming a contact to the PDSN 302. When the PPP session is set up, the PDSN 302 receives IP packets delivered from a CN 305 in step 702, and delivers the received IP packets to the AT 300 through PPP frames in step 703.

In step 704, the AT 300 detects its movement from a mobile communication network 310 to a wireless LAN 320 if a signal received from the BSS 301 becomes less than a threshold and a signal received from an AP 303 becomes greater than a threshold. The AT 300 determines the movement point from the mobile communication network to the wireless LAN for taking into account the strength of the received signal and a beacon message transmitted from the AP 303. The AT 300 detects the movement point from the mobile communication network to the wireless LAN on condition that strength of a signal received from the BSS 301 is less than a predetermined threshold, strength of a signal received from the AP 303 is greater than a predetermined threshold, and a beacon message is received from the AP 303. Upon detecting the movement point from the mobile communication network to the wireless LAN, the AT 300 searches for and selects the AR 304 that supports handoff from the mobile communication network to the wireless LAN in step 705, and determines to use a route extension technique if a user traffic state is the ‘active’ state. In order to detect the user traffic state, a flow state manager 402 of the AT 300 inquires of a flow monitor 401 via a socket interface 405. Upon receiving a notification for indicating transmission/reception of IP packets from the flow monitor 401, the flow state manager 402 sets the user traffic state to the ‘active’ state.

In step 706, the AT 300 performs IP address negotiation with the AP 304 selected in step 704. The “IP address negotiation” refers to a preparation process in which the AT 300 delivers its old IP address used in the mobile communication network and an IP address of the PDSN 302 to the AR 304 to set up a tunnel from the AR 304 to the PDSN 302. In step 707, the AR 304 sets up a tunnel to the PDSN 302 after completion of the IP address negotiation with the AT 300. After the tunnel is set up, IP packets delivered by the CN 305 to the AT 300 are delivered from the PDSN 302 to the AT 300 located in the wireless LAN 320 via the AR 304.

After completion of the handoff from the mobile communication network to the wireless LAN, the AT 300 starts monitoring the user traffic in step 708. In order to detect the user traffic state of the AT 300, the flow state manager 402 of the AT 300 periodically inquires of the flow monitor 401 via the socket interface 405.

In step 709, if IP packets from the CN 305 are delivered through the tunnel between the AR 304 and the PDSN 302, the flow state manager 402 of the AT 300 receives a notification for indicating transmission/reception of IP packets from the flow monitor 401. Then the flow state manager 402 sets the user traffic state to the ‘active’ state.

However, upon receiving a notification for indicating non-transmission/reception of IP packets from the flow monitor 401, the flow state manager 402 of the AT 300 sets the user traffic state to the ‘idle’ state in step 710.

That is, if no traffic exists between the CN 305 and the AT 300 for a predetermined time after the completion of the handoff from the mobile communication network to the wireless LAN, the flow state manager 402 changes the user traffic state of the AT 300 to the ‘idle’ state. In the ‘idle’ state of the user traffic state, the AT 300 determines to change the Layer 3 contact from the PDSN 302 to the AR 304.

Thereafter, in step 711, the AT 300 generates a DHCPINFORM message comprising the ‘A-P tunnel request’ option shown in Table 1 and delivers the generated DHCPINFORM message to the AR 304. In this case, the AT 300 sets an ‘anchor IP’ value of the ‘A-P tunnel request’ option to an IP address of the PDSN 302, and sets a REL flag of a ‘request flag’ to ‘1’.

Upon receiving the DHCPINFORM message, the AR 304 releases, in step 712, the tunnel to the PDSN 302 depending on an ‘A-P parameter’ option included in the DHCPINFORM message, and deletes routing information for the IP address of the AT 300. In step 713, the AR 304 delivers a DHCPACK message to the AT 300 to inform the release of the tunnel to the PDSN 302.

In step 714, the AT 300 generates a DHCPREQUEST message and delivers the DHCPREQUEST message to the AR 304 to be allocated a new IP address from the AR 304.

Upon receiving the DHCPREQUEST message, the AR 304 determines, in step 715, an IP address to be newly allocated to the AT 300 and sets routing information for the IP address of the AT 300.

In step 716, the AR 304 generates a DHCPACK message comprising the IP address allocated to the AT 300 and the IP setting information, and delivers the DHCPACK message to the AT 300.

Therefore, an exemplary embodiment of the present invention can determine whether to extend a route when the AT 300 performs handoff from the mobile communication network to the wireless LAN. If the AT 300 no longer transmits IP packets after handoff from the mobile communication network to the wireless LAN, an exemplary embodiment of the present invention can change the Layer 3 contact from the PDSN 302 to the AR 304, and end the route extension. Thus, according to an exemplary embodiment of the present invention a smooth handoff from the mobile communication network to the wireless LAN occurs even though the AT is in an active state, and PDSN 302 resources are advantageously release after the AT enters an idle state.

An exemplary embodiment of the present invention advantageously extends the route only when necessary even though the AT performs handoff from the mobile communication network to the wireless LAN, thereby contributing to a reduction in signaling load of the core network and waste of network resources.

Even though the AT extends the route and performs handoff from the mobile communication network to the wireless LAN, the AT can change the Layer 3 contact from the PDSN to the AR and end the route extension if no user traffic exists. In this manner, it is possible to efficiently manage an IP address allocated to the AT by the PDSN, reducing a tunneling load between the PDSN and the AR.

The novel handoff method preferably defines signaling messages between the AT and the network devices by simply extending the existing messages and processes, thus facilitating the implementation and application thereof.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. A handoff method between a mobile communication network including a packet data service node (PDSN), connected to a base station system (BSS), for supporting an Internet protocol (IP) routing function, and a wireless local area network (LAN) including an access router (AR) supporting the IP routing function, comprising the steps of:
exchanging a data packet with a correspondent node (CN) via a tunnel between the AR and the PDSN by an access terminal (AT) with a contact set up to the PDSN upon detecting handoff to the wireless LAN;
determining a user traffic state according to a transmission/reception state of the data packet; and
changing the contact connected to the AT according t the user traffic state.

2. The handoff method of claim 1, wherein the step of determining a user traffic state comprises the step of:
changing the user traffic state of the AT from an active state to an idle state if no transmission/reception of data packets occurs for a predetermined time.

3. The handoff method of claim 2, further comprising the step of:
changing the contact connected to the AT from the PDSN to the AR, if the user traffic state of the AT is changed from the active state to the idle state.

4. The handoff method of claim 3, further comprising the step of:
releasing the tunnel between the AR and the PDSN and receiving a new IP address allocated from the AR if the contact connected to the AT is changed from the PDSN to the AR.

5. The handoff method of claim 1, wherein the step of determining a user traffic state comprises the step of:
changing the user traffic state from an idle state to an active state if user traffic lasting occurs within a predetermined time.

6. A handoff method between a mobile communication network including a packet data service node (PDSN), connected to a base station system (BSS), for supporting an Internet protocol (IP) routing function, and a wireless local area network (LAN) including an access router (AR) supporting the IP routing function, comprising the steps of:
detecting movement to the wireless LAN by an access terminal (AT) with a contact set up to the PDSN;
providing the AR with information for tunneling between the PDSN and the AR;
setting up a tunnel for data packet delivery between the AR and the PDSN;
exchanging one or more data packet with a correspondent node (CN) via the tunnel;
determining a user traffic state according to a transmission/reception state of the data packet; and
changing the contact connected to the AT according to the user traffic state.

7. The handoff method of claim 6, wherein the step of determining a user traffic state comprises the step of:
changing the user traffic state of the AT from an active state to an idle state if no transmission/reception of data packets occurs for a predetermined time.

8. The handoff method of claim 7, further comprising the step of:
changing the contact of the AT from the PDSN to the AR, if the user traffic state of the AT is changed from the active state to the idle state.

9. The handoff method of claim 8, further comprising the step of:
releasing a tunnel between the AR and the PDSN and receiving a new IP address allocated from the AR if the contact of the AT is changed from the PDSN to the AR.

10. The handoff method of claim 6, wherein the step of determining a user traffic state comprises the step of:
changing the user traffic state from an idle state to an active state if at least one data packet is exchanged within a predetermined time.

11. A handoff apparatus for an access terminal (AT) that moves from a mobile communication network including a packet data service node (PDSN), connected to a base station system (BSS), for supporting an Internet protocol (IP) routing function, to a wireless local area network (LAN) including an access router (AR) supporting the IP routing function, comprising:
a flow monitor for providing information indicating a transmission/reception state of data packets of the AT; and
a flow state manager for determining a user traffic state according to the transmission/reception state of the data packets, and changing a contact of the AT according to the user traffic state.

12. The handoff apparatus of claim 11, wherein the flow state manager changes the user traffic state of the AT from an active state to an idle state if no transmission/reception of data packets occurs for a predetermined time.

13. The handoff apparatus of claim 12, wherein the flow state manager changes the contact of the AT from the Packet Data Service Node (PDSN) to the AR, if the user traffic state of the AT is changed from the active state to the idle state.

14. The handoff apparatus of claim 13, wherein after changing the contact of the AT from the PDSN to the AR, the flow state manager releases the tunnel between the AR and the PDSN and receives a new IP address allocated from the AR.

15. The handoff apparatus of claim 11, wherein the flow state manager changes the user traffic state from an idle state to an active state if user traffic occurs for a predetermined time.

16. A wireless communication system for performing handoff of an access terminal (AT) that moves from a mobile communication network including a packet data service node (PDSN), connected to a base station system (BSS), for supporting an Internet protocol (IP) routing function, to a wireless local area network (LAN) including an access router (AR) supporting the IP routing function, comprising:
the AT having a dual-mode function of accessing both the mobile communication network and the wireless LAN, for determining a user traffic state according to a transmission/reception state of data packets and changing a contact according to the user traffic state; and
the AR for allocating a new Internet Protocol (IP) address to the AT if the contact of the AT is changed.

17. The wireless communication system of claim 16, wherein the AT comprises:
a flow monitor for providing information indicating the transmission/reception state of the data packets; and
a flow state manager for determining the user traffic state according to the transmission/reception state of the data packets from the flow monitor, and changing the contact of the AT according to the user traffic state.

18. The wireless communication system of claim 17, wherein the flow state manager changes the user traffic state of the AT from an active state to an idle state if no transmission/reception of data packets occurs for a predetermined time.

19. The wireless communication system of claim 17, wherein the flow state manager changes the contact of the AT from the PDSN to the AR, if the user traffic state of the AT is changed from the active state to the idle state.

20. The wireless communication system of claim 19, wherein after changing the contact of the AT from the PDSN to the AR, the flow state manager releases a tunnel between the AR and the PDSN and receives a new IP address allocated from the AR.

21. The wireless-communication system of claim 16, wherein the flow state manager changes the user traffic state from an idle state to an active state if user traffic occurs within a predetermined time.
